(19) United States
(12) Patent Application Publication
(10) Pub. No.: US 2020/0039310 A1
(43) Pub. Date: Feb. 6, 2020

(54) DAMPING AIR SPRING WITH VARIABLE PISTON VOLUME

(71) Applicant: Hendrickson USA, L.L.C., Itasca, IL (US)

(72) Inventors: Damon Delorenzis, PLAINFIELD, IL (US); Jeff R. Zawacki, Channahon, IL (US)

(21) Appl. No.: 16/529,847

(22) Filed: Aug. 2, 2019

Related U.S. Application Data
(60) Provisional application No. 62/714,943, filed on Aug. 6, 2018.

(51) Int. Cl. B60G 11/27; F16F 9/04; F16F 9/05

(52) U.S. Cl. CPC B60G 11/27; F16F 9/049; B60G 2206/42; B60G 2202/152; F16F 9/057

(57) ABSTRACT

A damping air spring for a heavy-duty vehicle axle/suspension system includes a bellows and a piston. The bellows has a bellows chamber. The piston is operatively connected to the bellows and includes at least two portions forming a continuous piston chamber. One of the portions of the piston is at least partially disposed within the bellows chamber and has a variable volume.

### CROSS-REFERENCE TO RELATED APPLICATION

This application claims the benefit of U.S. Provisional Patent Application No. 62/714,943, filed Aug. 6, 2018.

### BACKGROUND OF THE INVENTION

### Field of the Invention

The present invention relates generally to the art of axle/suspension systems for heavy-duty vehicles. In particular, the present invention relates to axle/suspension systems for heavy-duty vehicles that utilize an air spring to cushion the ride of the heavy-duty vehicle. More particularly, the present invention is directed to an air spring with damping characteristics for a heavy-duty vehicle axle/suspension system that includes a piston with a variable, flexible, or collapsible piston portion extending into and occupying a portion of the bellows chamber and having a variable or non-fixed volume that is continuous with a constant or fixed volume of a rigid piston portion, thus providing an air spring with increased damping energy by reducing bellows air volume without reducing the travel of the air spring or requiring additional space or weight.

### Background Art

The use of axle/suspension systems has been very popular in the heavy-duty vehicle industry for many years. For the purposes of clarity and convenience, reference is made to a heavy-duty vehicle with the understanding that such reference includes trucks, tractor-trailers or semi-trailers, trailers, and the like. Although axle/suspension systems can be found in widely varying structural forms, in general their structure is similar in that each system typically includes a pair of suspension assemblies. The suspension assemblies are typically connected directly to a primary frame of the heavy-duty vehicle or a subframe supported by the primary frame. For those heavy-duty vehicles that support a subframe, the subframe can be non-movable or movable, the latter being commonly referred to as a slider box, slider subframe, slider undercarriage, secondary slider frame, or bogey.

Typically, each suspension assembly of an axle/suspension system includes a longitudinally extending elongated beam. The beam may extend rearwardly or frontwardly relative to the front of the heavy-duty vehicle, thus defining what are typically referred to as trailing- or leading-arm axle/suspension systems, respectively. However, for purposes of the description contained herein, it is understood that the term “trailing-arm” will encompass beams which extend either rearwardly or frontwardly with respect to the front end of the heavy-duty vehicle. Each beam typically is located adjacent to and below a respective one of a pair of spaced-apart longitudinally extending main members and one or more cross members, which form the frame of the heavy-duty vehicle. For the purposes of clarity and convenience, reference herein will be made to main members with the understanding that such reference is by way of example and includes main members of primary frames, movable subframes, and non-movable subframes. Each beam is pivotally connected at one of its ends to a hanger, which in turn is attached to, and depends from, a respective one of the main members of the heavy-duty vehicle. An axle extends transversely between, and typically is connected to, the beams of the pair of suspension assemblies at a selected location from about the mid-point of each beam to the end of the beam opposite its pivotal connection end. The beam end opposite the pivotal connection end is also connected to an air spring, or other spring mechanism, which, in turn, is connected to a respective one of the main members. A brake system and, optionally, one or more shock absorbers for providing damping to the axle/suspension system of the heavy-duty vehicle also are mounted on the axle/suspension system.

The axle/suspension systems of the heavy-duty vehicle act to cushion the ride, dampen vibrations, and stabilize the heavy-duty vehicle. More particularly, as the heavy-duty vehicle is traveling over the road, the wheels encounter road conditions that impart various forces, loads, and/or stresses, collectively referred to herein as forces, to the respective axle on which the wheels are mounted, and in turn, to the suspension assemblies that are connected to and support the axle. These forces include vertical forces caused by vertical movement of the wheels as they encounter certain road conditions, fore-aft forces caused by acceleration and deceleration of the heavy-duty vehicle as well as certain road conditions, and side-load and torsional forces associated with transverse heavy-duty vehicle movement, such as turning and lane-change maneuvers.

In order to minimize the detrimental effect of these forces on the heavy-duty vehicle during operation, the axle/suspension system is designed with structural characteristics to react and/or absorb at least some of the forces. In particular, it is desirable for an axle/suspension system to have beams that are fairly stiff in order to minimize the amount of sway experienced by the heavy-duty vehicle and thus provide roll stability, as is known. However, it is also desirable for an axle/suspension system to be relatively flexible to cushion the heavy-duty vehicle from vertical impacts and provide compliance to resist failure and increase durability. It is also desirable to dampen the vibrations or oscillations that result from such forces to provide a more comfortable ride and reduce irregular wear of the tires.

A key component of the axle/suspension system that cushions the ride of the heavy-duty vehicle from vertical impacts is the air spring. Conventional air springs utilized in heavy-duty air-ride axle/suspension systems are typically characterized as either non-damping or damping. A non-damping air spring typically includes three main components: a flexible bellows, a piston, and a bellows top plate. The bellows is formed from rubber or other flexible material, and is operatively mounted on top of the piston. The piston is typically formed from steel, aluminum, fiber reinforced plastics, or other suitably rigid materials, and is mounted by fasteners on the top plate of a respective one of the beams of the suspension assembly of the axle/suspension system, as is known. The air spring bellows is filled with a volume of pressurized air provided to the air spring via an air tank or air reservoir operatively connected to the air spring and attached to the heavy-duty vehicle. The volume of pressurized air, or “air volume”, that is contained within the air spring is a major factor in determining the spring rate, or stiffness, of the air spring. The greater the air volume of the air spring, the lower the spring rate, or stiffness, of the air spring. During normal heavy-duty vehicle operations on city roads, or off-highway, a lower spring rate, or reduced stiffness, is generally more desirable because it provides a softer ride to the heavy-duty vehicle.

Prior art non-damping air springs, while providing cushioning to the cargo and occupant(s) during heavy-duty vehicle operation, provide little or no damping to the axle/suspension system. Such damping characteristics are, instead, typically provided by one or more hydraulic shock absorbers. The shock absorbers are mounted on and extend between the beam of a respective one of the suspension assemblies and a respective one of the main members of the heavy-duty vehicle. The shock absorbers are generally configured to provide damping optimized for operation of the heavy-duty vehicle at a ride height at which the bellows volume of the air spring provides a specific spring rate, or stiffness, as is known. Although shock absorbers provide damping to the axle/suspension system, they undesirably add complexity and weight to the axle/suspension system. Moreover, the shock absorbers are a service item of the axle/suspension system that require maintenance and/or replacement from time to time, creating additional maintenance and/or replacement costs.

In order to eliminate the need for shock absorbers to provide damping to the heavy-duty vehicle axle/suspension system, air springs with damping characteristics, or damping air springs, such as the one shown and described in U.S. Pat. No. 8,540,222, and assigned to the Applicant of the instant application, Hendrickson USA, L.L.C., have been utilized. A damping air spring is typically similar in structure to a non-damping air spring, except that the damping air spring includes a piston chamber incorporating a volume of air that is in fluid communication with the bellows via at least one opening formed in the piston and providing restricted communication of air between the piston chamber and the bellows during operation of the axle/suspension system.

Restricted communication of air between the piston chamber and the bellows during heavy-duty vehicle operation provides damping to the axle/suspension system. The air volume of the bellows and piston chamber are major factors in determining the damping energy of the air spring. A relatively smaller bellows volume combined with a relatively larger piston chamber volume provide the air spring with increased damping energy. This increased damping energy provides a more controlled ride motion of the sprung mass of the heavy-duty vehicle during operation, which is generally more desirable.

When the axle/suspension system experiences a jounce event, such as when the wheels of the heavy-duty vehicle encounter a curb or a raised bump in the road, the axle moves vertically upwardly toward the heavy-duty vehicle chassis. In such an event, the bellows is compressed by the axle/suspension system as the wheels of the heavy-duty vehicle travel over the curb or the raised bump in the road. The compression of the air spring bellows causes the internal pressure of the bellows to increase, creating a pressure differential between the bellows and the piston chamber. This pressure differential causes air to flow from the bellows through the opening(s) into the piston chamber. Air will continue to flow back and forth through the opening(s) between the bellows and the piston chamber until the pressures of the piston chamber and the bellows have equalized. The restricted flow of air back and forth through the opening(s) causes damping to occur.

Conversely, when the axle/suspension system experiences a rebound event, such as when the wheels of the heavy-duty vehicle encounter a large hole or depression in the road, the axle moves vertically downwardly away from the heavy-duty vehicle chassis. In such an event, the bellows is expanded, or pulled downwardly, by the axle/suspension system as the wheels of the heavy-duty vehicle travel into the hole or depression in the road. The expansion of the air spring bellows causes the internal pressure of the bellows to decrease, creating a pressure differential between the bellows and the piston chamber. This pressure differential causes air to flow from the piston chamber through the opening(s) into the bellows. Air will continue to flow back and forth through the opening(s) between the bellows and the piston chamber until the pressures of the piston chamber and the bellows have equalized. The restricted flow of air back and forth through the opening(s) causes damping to occur.

Prior art air springs with damping characteristics have certain potential disadvantages, drawbacks, and limitations due to their structure. In a typical prior art damping air spring, the rigid or fixed nature of the piston chamber does not allow reduction of the bellows volume without generally limiting air spring travel, since a smaller bellows will not be able to accommodate a large jounce motion without the bellows top plate contacting the top of the piston. Limiting air spring travel is generally undesirable because it may potentially limit the ability of the air spring to effectively react forces during jounce events. Moreover, the limitations with respect to bellows volume and piston chamber volume for prior art air springs with damping characteristics necessarily limit the damping energy that the prior art air spring can provide. As a result, decreasing the bellows volume and increasing the size of the piston, and thus the piston chamber volume, to achieve greater damping energy, results in the bellows chamber having limited travel during jounce events. In addition, increasing the size of the piston, and thus the piston chamber volume, typically increases the weight of, and space required for, the air spring, thereby reducing the amount of payload that the heavy-duty vehicle can carry. Therefore, it is desirable to have an air spring with increased damping features that makes it possible to have a decreased bellows volume and an increased piston volume that does not adversely limit air spring travel or add weight to, or require additional space for, the air spring.

The air spring with damping features for heavy-duty vehicles of the present invention overcomes the potential disadvantages, drawbacks, and limitations associated with the prior art air springs by providing a piston having a variable, non-fixed, flexible piston chamber portion that projects into the bellows chamber, which exhibits variable volume characteristics during extreme jounce events, thereby increasing piston chamber volume and decreasing bellows volume without changing or limiting air spring travel. By providing an air spring for heavy-duty vehicles having a flexible piston chamber portion, greater damping energy can be provided to the axle/suspension system without limiting travel and/or increasing weight or space requirements, allowing the heavy-duty vehicle to carry more payload.

### SUMMARY OF THE INVENTION

Objectives of the present invention include providing an air spring with damping features that provides greater damping energy without changing or limiting the travel height of the air spring.

A further objective of the present invention is to provide an air spring with damping features that reduces the need for larger air volumes to increase damping characteristics, thereby reducing the space required for the air spring in the axle/suspension system and providing increased space for heavier payload or cargo.

These objectives and advantages are obtained by the damping air spring for heavy-duty vehicle axle/suspension systems of the present invention, which includes a bellows and a piston. The bellows has a bellows chamber. The piston is operatively connected to the bellows and has at least two portions forming a continuous piston chamber. At least the first portion of the piston is at least partially disposed within the bellows chamber, the piston first portion having a variable volume.

These objectives and advantages are also obtained by the damping air spring for heavy-duty vehicle axle/suspension systems of the present invention, which includes: a bellows having a bellows chamber; and a piston operatively connected to the bellows and having at least a first portion and a second portion forming a continuous piston chamber, wherein at least the first portion of the piston is at least partially disposed within the bellows chamber, the piston first portion having a variable volume, and wherein at least the first portion and the bellows are formed from a material as a single piece.

### BRIEF DESCRIPTION OF THE SEVERAL VIEWS OF THE DRAWINGS

The preferred embodiment of the present invention, illustrative of the best mode in which applicant has contemplated applying the principles, is set forth in the following description and shown in the drawings, and is particularly and distinctly pointed out and set forth in the appended claims.

FIG. 1 is a rear driver-side perspective view of an axle/suspension system utilizing a pair of prior art damping air springs;

FIG. 2 is a perspective view, in section, of a prior art air spring with damping characteristics, showing the bellows chamber in restricted fluid communication with the piston chamber via a pair of openings;

FIG. 3 is an elevational view, in section, of an exemplary embodiment damping air spring of the present invention, showing the piston chamber having a pair of portions with a continuous volume in restricted fluid communication with the bellows chamber via a pair of openings, and showing a flexible portion of the piston chamber extending into the bellows chamber;

FIG. 3A is an elevational view, in section, of the exemplary embodiment damping air spring shown in FIG. 3, showing the air spring in a compressed state;

FIG. 4 is a top perspective view, partially in section, of the exemplary embodiment damping air spring of the present invention shown in FIG. 3;

FIG. 5 is a bottom perspective view of the exemplary embodiment damping air spring of the present invention shown in FIGS. 3-4, and

FIG. 6 is an elevational view, in section, of an alternative exemplary embodiment damping air spring of the present invention, showing the upper portion of the piston and the bellows formed from a single piece of material.

Similar reference characters refer to similar parts throughout.

### DESCRIPTION OF THE PREFERRED EMBODIMENT

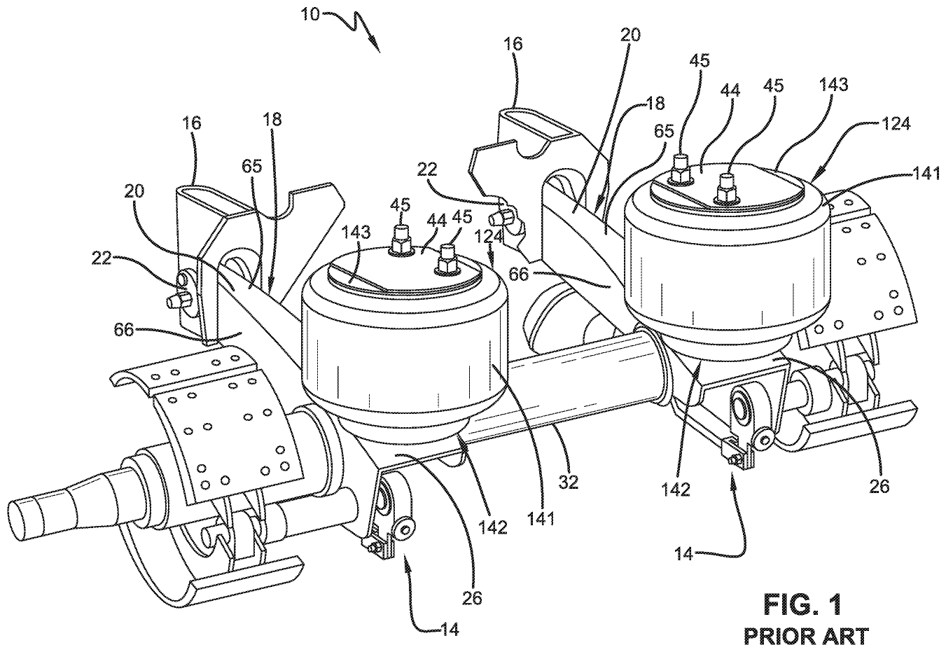

In order to better understand the environment in which the damping air spring with variable or non-fixed piston volume of the present invention is utilized, an air-ride axle/suspension system 10 incorporating a prior art damping air spring 124 is shown in FIG. 1 and will now be described in detail below.

It should be noted that axle/suspension system 10 typically includes a pair of mirror-image suspension assemblies 14, each suspended from a respective longitudinally-extending transversely spaced-apart main member (not shown) of a heavy-duty vehicle (not shown). Because suspension assemblies 14 are mirror images, and for the purposes of clarity and conciseness, only one of the suspension assemblies will be described below.

Suspension assembly 14 is pivotally connected to a hanger 16 via a beam 18. Beam 18 is formed having a generally upside-down integrally formed U-shape with a pair of sidewalls 66 and a top plate 65 with the open portion of the beam facing generally downwardly. A bottom plate (not shown) extends between and is attached to the lowermost ends of sidewalls 66 by any suitable means, such as welding, to complete the structure of beam 18. Beam 18 includes a front end 20 having a bushing assembly 22 to facilitate pivotal connection of the beam to hanger 16, as is known. An axle 32 is captured by beam 18. Suspension assembly 14 also includes damping air spring 124, which is mounted on and extends between a rear end 26 of beam 18 and the main member of the heavy-duty vehicle.

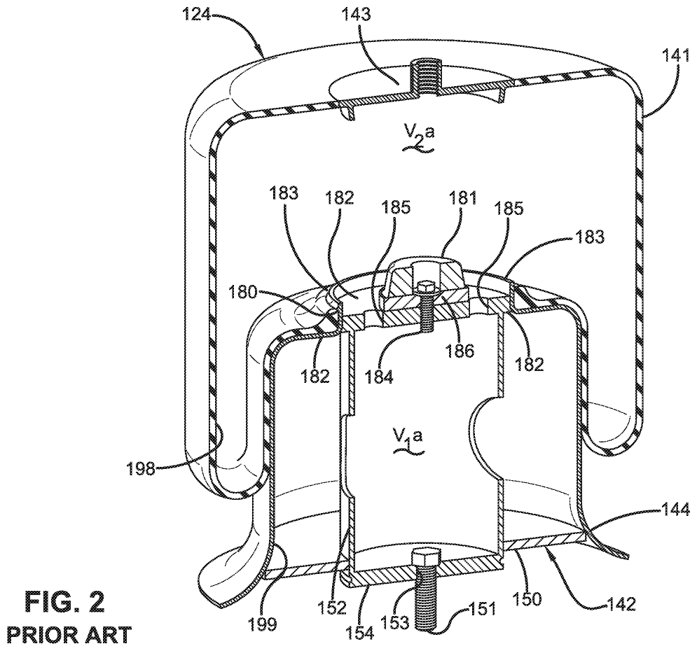

With additional reference to FIG. 2, air spring 124 includes a bellows 141 and a piston 142. The top end of bellows 141 is sealingly engaged with a bellows top plate 143, as is known. An air spring mounting plate 44 (FIG. 1) is mounted on the top surface of top plate 143 by fasteners 45, which are also used to mount the top portion of air spring 124 to a respective one of the main members of the heavy-duty vehicle. Alternatively, bellows top plate 143 could be mounted directly on a respective one of the main members of the heavy-duty vehicle, as is known. Piston 142 is generally cylindrical-shaped and includes a continuous generally stepped sidewall 144 attached to, and extending between, a generally flat bottom plate 150 and an integrally formed top plate 182. Top plate 182 includes a central disc or plug and a support area that extends radially outward from the central disc. Bottom plate 150 is formed with an upwardly extending central hub 152. Central hub 152 includes a bottom plate 154 formed with a central opening 153. A fastener 151 is disposed through opening 153 in order to attach piston 142 to beam top plate 65 at beam rear end 26. Bottom plate 150, sidewall 144, and top plate 182 of piston 142 define a piston chamber 199 having an internal volume V₁a.

Top plate 182 of piston 142 is formed with a circular upwardly extending protrusion 183 having a lip 180 formed about its circumference. Lip 180 cooperates with the lowermost end of bellows 141 to form an airtight seal between the bellows and the lip, as is known. Bellows 141, top plate 143, and piston top plate 182 define a bellows chamber 198 having an internal volume V₂a at standard static or design ride height. For a heavy-duty vehicle having a gross axle weight rating (GAWR) of about 20,000 lbs., piston chamber volume V₁a and bellows chamber volume V₂a are typically about 240 in.³ and about 485 in.³, respectively.

Top plate 182 is formed with a pair of circular-shaped openings 185, which allow fluid communication between piston chamber volume V₁a and bellows chamber volume V₂a. More particularly, openings 185 allow fluid or air to pass between piston chamber 199 and bellows chamber 198 during operation of the heavy-duty vehicle. For a heavy-duty vehicle having a GAWR of about 20,000 lbs., openings 185 typically have a combined cross-sectional area of about 0.06 in.². The ratio of the cross-sectional area of openings 185 measured in square inches to the volume of piston chamber 199 measured in cubic inches to the volume of bellows chamber 198 measured in cubic inches is in the range of ratios of from about 1:600:1200 to about 1:14100:23500.

A bumper mounting plate 186 is mounted on piston top plate 182 by a fastener 184. A bumper 181 is rigidly attached to bumper mounting plate 186 in a well-known manner and extends upwardly from the top surface of the bumper mounting plate. Bumper 181 serves as a cushion to prevent contact between piston top plate 182 and bellows top plate 143, which can potentially cause damage to the plates and air spring 124 during air loss or extreme jounce events during operation of the heavy-duty vehicle.

Prior art axle/suspension system 10 is designed to react and/or absorb forces that act on the heavy-duty vehicle during operation. In particular, it is desirable for axle/suspension system 10 to be rigid or stiff in order to resist roll forces and thus provide the heavy-duty vehicle with roll stability. This is typically accomplished by utilizing beam 18, which is rigid and also rigidly attached to axle 32. However, it is also desirable for axle/suspension system 10 to be flexible to assist in cushioning the heavy-duty vehicle from vertical impacts and to provide the axle/suspension system with compliance to resist failure. Such flexibility is typically achieved through the pivotal connection of beam 18 to hanger 16 with bushing assembly 22. In addition, air spring 124 cushions the ride of the heavy-duty vehicle for cargo and passengers. Piston chamber volume V₁a, bellows chamber volume V₂a, and the cross-sectional area of openings 185, all in relation to one another, provide application-specific damping characteristics at standard temperature and pressure to air spring 124 during operation of the heavy-duty vehicle.

When axle 32 of axle/suspension system 10 experiences a jounce event, such as when the heavy-duty vehicle wheels encounter a curb or a raised bump in the road, the axle moves vertically upwardly toward the chassis. In such a jounce event, bellows chamber 198 is compressed by axle/suspension system 10 as the wheels of the heavy-duty vehicle travel over the curb or the raised bump in the road. The compression of air spring bellows chamber 198 causes the internal pressure of the bellows chamber to increase, creating a pressure differential between the bellows chamber and piston chamber 199. This pressure differential causes air to flow from bellows chamber 198 through piston top plate openings 185 into piston chamber 199. The restricted flow of air between bellows chamber 198 and piston chamber 199 through piston top plate openings 185 causes damping to occur. Air continues to flow back and forth through piston top plate openings 185 until the pressures of piston chamber 199 and bellows chamber 198 have equalized.

Conversely, when axle 32 of axle/suspension system 10 experiences a rebound event, such as when the heavy-duty vehicle wheels encounter a large hole or depression in the road, the axle moves vertically downwardly away from the chassis. In such a rebound event, bellows chamber 198 is expanded, or pulled downwardly, by axle/suspension system 10 as the wheels of the heavy-duty vehicle travel into the hole or depression in the road. The expansion of air spring bellows chamber 198 causes the internal pressure of the bellows chamber to decrease, creating a pressure differential between the bellows chamber and piston chamber 199. This pressure differential causes air to flow from piston chamber 199 through openings 185 into bellows chamber 198. The restricted flow of air through openings 185 causes damping to occur. Air will continue to flow back and forth through openings 185 until the pressures of piston chamber 199 and bellows chamber 198 have equalized.

Prior art air spring 124 with damping characteristics, although satisfactory for performing its intended damping function, has certain potential disadvantages, drawbacks, and limitations due to its structure. For example, prior art air spring 124 uses a relatively small, constant, or fixed, piston chamber volume V₁a. The limited piston chamber volume V₁a and relatively large bellows chamber volume V₂a of prior art air spring 124 decreases the damping energy of the air spring. In addition, the structure and placement of prior art air spring 124 does not lend itself to easily decreasing bellows chamber volume V₂a and increasing the constant, or fixed, piston chamber volume V₁a, and thus the size of piston 142, in order to provide the prior art air spring with increased damping energy, because doing so limits or restricts the travel height of the air spring, which potentially limits the ability of the air spring to effectively absorb and/or react forces during jounce events. Moreover, increasing the size of piston 142 without decreasing the bellows chamber volume V₂a increases the weight and amount of space required for prior art air spring 124, thereby potentially reducing the amount of payload the heavy-duty vehicle can carry.

The air spring with damping characteristics of the present invention overcomes the disadvantages, drawbacks, and limitations of prior art air spring 124 and will be described in detail below.

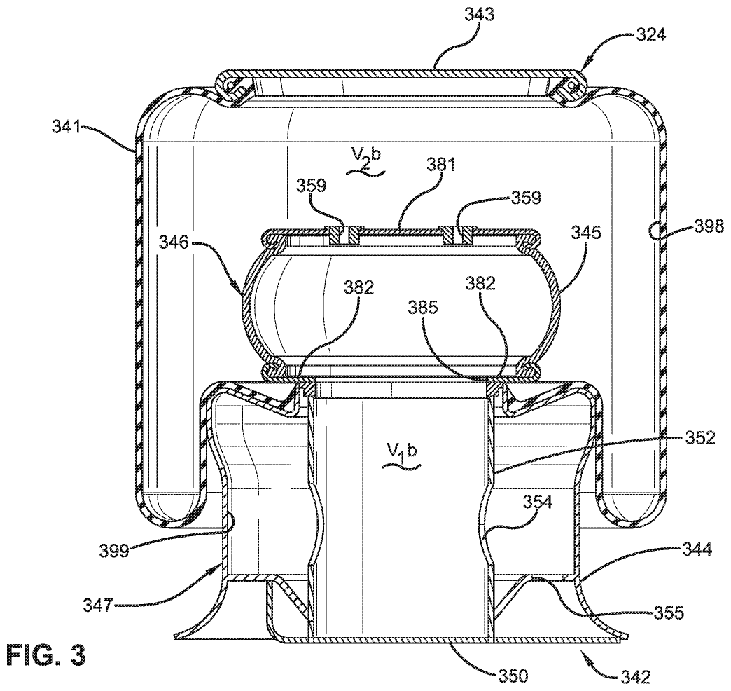

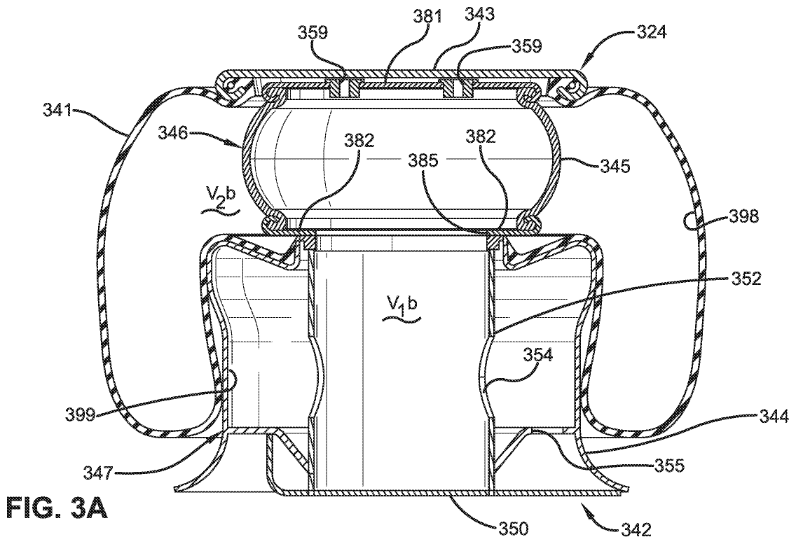

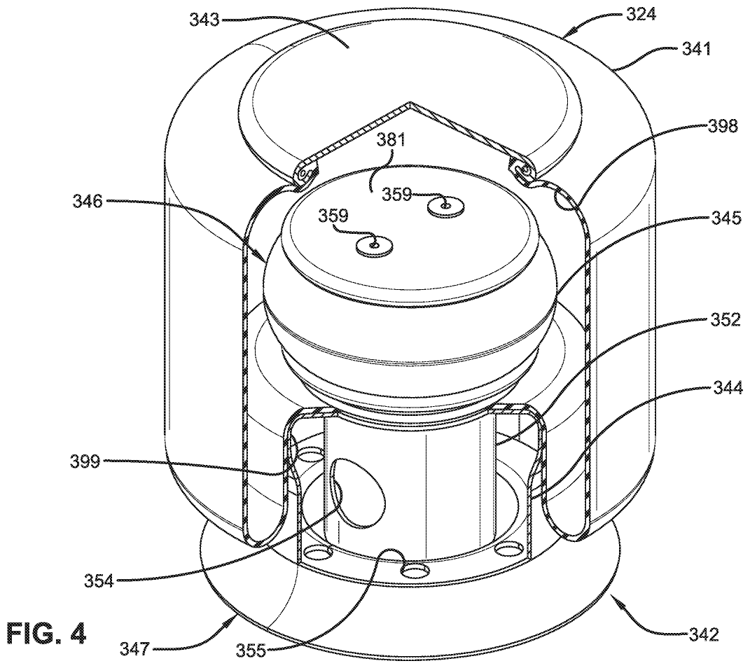

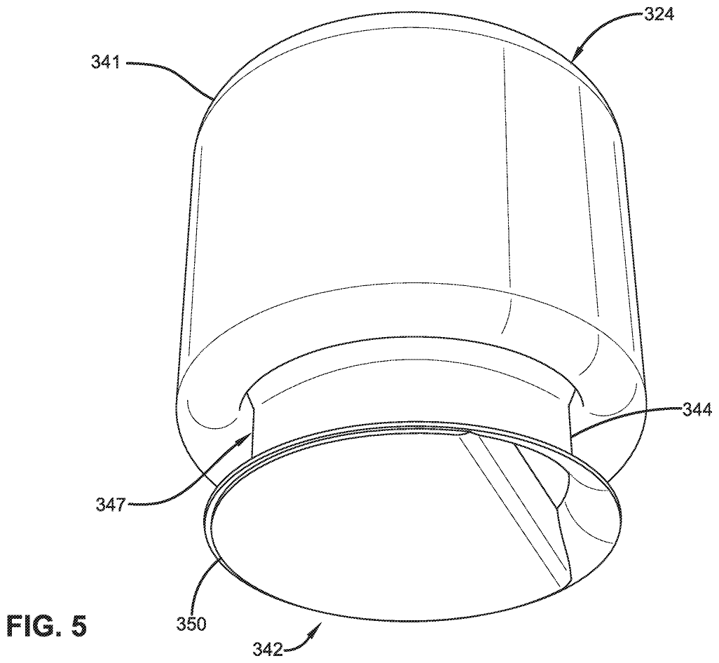

An exemplary embodiment damping air spring 324 with variable or non-fixed piston volume, according to the present invention, is shown in FIGS. 3-6. Air spring 324 is typically incorporated into an axle/suspension system, such as axle/suspension system 10 or any other suitable air-ride axle/suspension system.

Air spring 324 includes a bellows 341, a bellows top plate 343, and a piston 342. Piston 342 is generally cylindrical having an upper portion 346 with an upper sidewall 345 and a top plate 381. Piston 342 also includes a lower portion 347 with a lower sidewall 344 and a bottom plate 350. Top plate 381 and sidewall 345 of piston upper portion 346 along with sidewall 344 and bottom plate 350 of piston lower portion 347 define a piston chamber 399 having a variable internal volume V₁b. Lower piston portion 347 includes a generally cylindrical central support column 352 operatively connected to and extending between a fastening plate 382 and bottom plate 350. Fastening plate 382 is generally ring-like and is formed with an opening or passage 385 between upper and lower piston portions 346, 347, respectively. Passage 385 provides unrestricted fluid communication between upper and lower piston portions 346, 347, respectively, such that the internal volumes of the upper and lower piston portions are continuous and contribute to variable internal volume V₁b. Central support column 352 includes one or more openings 354 and a plurality of reinforcement ring openings 355 that provide fluid communication, such that the internal volume of the central support column is continuous with and contributes to piston variable internal volume V₁b. The top end of bellows 341 is sealingly engaged with bellows top plate 343 in a known manner. Bellows 341, top plate 343, upper sidewall 345, and piston top plate 381 define a bellows chamber 398 having an internal volume V₂b.

As noted above, air spring 324 is incorporated into an axle/suspension system, such as axle/suspension system 10 described above. In such a configuration, bottom plate 350 rests on beam top plate 65 (FIG. 1) at beam rear end 26 and is attached thereto in a manner known in the art, such as by fasteners or bolts (not shown). An air spring mounting plate 44 (FIG. 1) is mounted on the top surface of top plate 343 by fasteners 45, which are also used to mount the top portion of air spring 324 to a main member (not shown) of the heavy-duty vehicle (not shown). Alternatively, top plate 343 could be mounted directly to the main member without changing the overall concept or operation of the present invention.

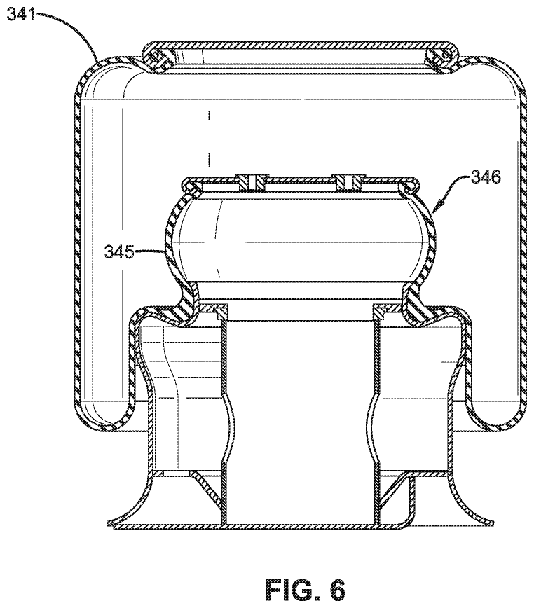

In accordance with one of the primary features of the present invention, upper sidewall 345 is operatively connected to and extends between piston top plate 381 and fastening plate 382. Upper sidewall 345 is formed from rubber, plastic, or other suitable compliant or flexible material, sufficient to allow the sidewall to undergo vertical compression and extension, such that it can be made to collapse during extreme jounce events. The compliant material of upper sidewall 345 may also be reinforced using one or more supporting structures, such as, for example, metal or plastic rings or one or more layers of compliant, semi-rigid, or rigid material. Lower sidewall 344 is formed from metal, plastic, composite, or other suitable rigid material and provides support for the rolling lobe of the compressed bellows 341 as well as for the flexible upper sidewall 345 of flexible upper piston portion 346. It is contemplated that the flexible upper piston portion 346, including upper sidewall 345, and flexible bellows 341 may be formed from the same material and/or in a single piece, as shown in FIG. 6, but it is otherwise generally identical to exemplary embodiment air spring 324 described above.

In accordance with another primary feature of the present invention, a pair of openings 359 are formed in top plate 381 of piston 342 to provide restricted fluid communication between piston chamber 399 and bellows chamber 398. Top plate openings 359 have a generally circular-shaped cross-section but may have any other suitable cross-sectional shape, including oval, elliptical, or polygonal, without changing the overall concept or operation of the present invention. Piston top plate openings 359 preferably have an area in the range of from about 0.039 in.² (˜0.25 cm²) to about 0.13 in.² (˜0.84 cm²).

Upper piston portion 346 with connected piston top plate 381 extends generally upwardly from lower piston portion 347. As a result, upper piston portion 346 is disposed within or extends into bellows chamber 398, such that piston top plate 381 is spaced a distance from bellows top plate 343. The increase in total volume of piston chamber 399, due to the extension of upper piston portion 346 into bellows chamber 398, together with the corresponding decrease in total volume of the bellows chamber increases the damping energy of air spring 324. The separation or spacing between piston top plate 381 and bellows top plate 343 is maintained when air spring 324 is in an inflated state and under nominal load but decreases as the load on the air spring increases. As a result top plate 343 may contact piston top plate 381 during extreme jounce events and exert a force on upper piston portion 346, thereby causing upper sidewalls 345 to flex and/or collapse. The variable internal volume V₁b of piston chamber 399 varies in accordance with the flexed or collapsed state of upper sidewalls 345 and upper piston portion 346, preventing piston 342 from limiting or obstructing the compression of bellows 341 and changing the travel of the air spring during extreme jounce events. Thus, air spring 324 provides a greater damping energy than prior art air spring 124 without limiting air spring travel or increasing the overall size of the air spring, such that the air spring is relatively lighter in weight and requires less space in the axle/suspension system, thereby allowing the heavy-duty vehicle to carry more payload.

When axle 32 of axle/suspension system 10 experiences a jounce event, such as when the wheels of the heavy-duty vehicle encounter a curb or a raised bump in the road, the axle moves vertically upwardly toward the heavy-duty vehicle chassis. In such a jounce event, bellows chamber 398 is compressed, as shown in FIG. 3A, by axle/suspension system 10 as the wheels of the heavy-duty vehicle travel over the curb or the raised bump in the road. The compression of air spring bellows chamber 398 causes the internal pressure of the bellows chamber to increase. As a result, a pressure differential is created between bellows chamber 398 and piston chamber 399. This pressure differential causes air to flow from bellows chamber 398, through openings 359 into piston chamber 399. The flow of air back and forth through openings 359 into piston chamber 399 causes damping to occur. Air will continue to flow back and forth from piston chamber 399 to bellows chamber 398, and vice versa, until equilibrium is reached and the pressures in the piston chamber and the bellows chamber have equalized.

During an extreme jounce event, bellows chamber 398 becomes very compressed by axle/suspension system 10 as the wheels of the heavy-duty vehicle travel over the curb or the raised bump in the road. The extreme compression of bellows chamber 398 brings top plate 343 of air spring 324 into contact with piston top plate 381. The direct pressure from the contact between top plate 343 and piston top plate 381 causes upper sidewalls 345 to begin to collapse allowing further compression of bellows 341. In addition, the compression of upper sidewalls 345 causes a build-up of elastic energy within the structure of upper piston portion 346. As a result, this elastic energy stored in upper sidewall 345 can be released, causing upper piston portion 346 to regain its original shape within bellows chamber 398 as bellows top plate 343 moves upwardly, relieving forces acting on piston top plate 381 and upper sidewall 345.

Conversely, when axle 32 of axle/suspension system 10 experiences a rebound event, such as when the wheels of the heavy-duty vehicle encounter a large hole or depression in the road, the axle moves vertically downwardly away from the heavy-duty vehicle chassis. In such a rebound event, bellows chamber 398 is expanded, or pulled downwardly, by axle/suspension system 10 as the wheels of the heavy-duty vehicle travel into the hole or depression in the road. The expansion of bellows chamber 398 causes the internal pressure of the bellows chamber to decrease. As a result, a pressure differential is created between bellows chamber 398 and piston chamber 399. This pressure differential causes air to flow from piston chamber 399 through top plate openings 359 into bellows chamber 398. The flow of air back and forth between piston chamber 399 and bellows chamber 398 through piston top plate openings 359 causes damping to occur. Air will continue to flow back and forth from piston chamber 399 to bellows chamber 398, and vice versa, until equilibrium is reached and the pressures in the piston chamber and the bellows chamber have equalized.

Thus, exemplary embodiment damping air spring 324 of the present invention overcomes the disadvantages, drawbacks, and limitations associated with prior art air spring 124 by providing a piston having a variable, non-fixed, flexible or collapsible piston portion 346 in fluid communication with bellows chamber 398 that provides increased and variable piston volume and decreased bellows volume without limiting or changing the travel of the air spring. Moreover, exemplary embodiment damping air spring 324 provides increased damping energy without adding weight or requiring additional space, thus allowing the heavy-duty vehicle to carry more payload.

It is contemplated that the concepts shown in exemplary embodiment air spring 324 of the present invention could be utilized in any type of air spring utilized in conjunction with heavy-duty vehicles without changing the overall concept or operation of the present invention. It is also contemplated that exemplary embodiment air spring 324 of the present invention could be formed from various materials, including composites, metal, and the like, without changing the overall concept or operation of the present invention. It is further contemplated that exemplary embodiment air spring 324 of the present invention could be utilized in combination with prior art shock absorbers and/or other similar devices without changing the overall concept or operation of the present invention. It is even contemplated that any size, shape or number of openings 359, from a single opening to multiple openings, may be formed in top plate 381 of piston 342 without changing the overall concept or operation of the present invention. It is also contemplated that openings 359 of exemplary embodiment air spring 324 could be formed anywhere on piston top plate 381 or upper and lower piston portions 346, 347, respectively, without changing the overall concept or operation of the present invention.

It is contemplated that exemplary embodiment damping air spring 324 of the present invention could be utilized on all heavy-duty vehicles having one or more than one axle without changing the overall concept or operation of the present invention. It is further contemplated that exemplary embodiment air spring 324 of the present invention could be utilized on heavy-duty vehicles having frames or subframes which are moveable or non-movable without changing the overall concept or operation of the present invention. It is yet even further contemplated that exemplary embodiment air spring 324 of the present invention could be utilized on all types of air-ride leading- and/or trailing-arm beam-type axle/suspension systems, axle/suspension systems having overslung/top-mount configuration or underslung/bottom-mount configurations, or other types of air-ride rigid beam-type axle/suspension systems, such as those using U-bolts, U-bolt brackets/axle seats, and the like without changing the overall concept or operation of the present invention.

Accordingly, the air spring of the present invention is simplified and provides an effective, safe, inexpensive, and efficient structure and method that achieve all the enumerated objectives, provide for eliminating difficulties encountered with prior air springs, and solve problems and obtain new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed.

The present invention has been described with reference to the specific embodiment. It is to be understood that this illustration is by way of example and not by way of limitation. Potential modifications and alterations will occur to others upon a reading and understanding of this disclosure, and it is understood that the invention includes all such modifications, alterations, and equivalents thereof. Having now described the features, discoveries, and principles of the invention; the manner in which the air spring of the present invention is used and installed; the characteristics of the construction, arrangement, and method steps; and the advantageous, new, and useful results obtained, the new and useful structures, devices, elements, arrangements, process, parts, and combinations are set forth in the appended claims.

What is claimed is:

1. A damping air spring for a heavy-duty vehicle axle/suspension system comprising:
a bellows having a bellows chamber; and
a piston operatively connected to the bellows and having at least a first portion and a second portion forming a continuous piston chamber, wherein at least said first portion of said piston is at least partially disposed within said bellows chamber, the piston first portion having a variable volume.

2. The damping air spring for a heavy-duty vehicle axle/suspension system of claim 1, the air spring further comprising a means for restricted fluid communication between the bellows chamber and the piston chamber.

3. The damping air spring for a heavy-duty vehicle axle/suspension system of claim 2, the means for restricted fluid communication comprising one or more openings formed in at least one of the first portion and the second portion.

4. The damping air spring for a heavy-duty vehicle axle/suspension system of claim 1, the variable volume of the first portion reducing a volume of the bellows chamber to increase a damping energy of the air spring.

5. The damping air spring for a heavy-duty vehicle axle/suspension system of claim 1, wherein the first portion and the second portion of the piston are formed from different materials.

6. The damping air spring for a heavy-duty vehicle axle/suspension system of claim 5, the first portion being formed from a material that is flexible or compressible.

7. The damping air spring for a heavy-duty vehicle axle/suspension system of claim 6, the bellows further comprising a top plate;
wherein the top plate applies a force to the piston compressing the first portion and altering the variable volume.

8. The damping air spring for a heavy-duty vehicle axle/suspension system of claim 6, the second portion being formed from a material that is rigid.

9. The damping air spring for a heavy-duty vehicle axle/suspension system of claim 1, wherein at least the first portion and the bellows are formed from a material as a single piece.

10. A damping air spring for a heavy-duty vehicle axle/suspension system comprising:
a bellows having a bellows chamber; and
a piston operatively connected to the bellows and having at least a first portion and a second portion forming a continuous piston chamber, wherein at least said first portion of said piston is at least partially disposed within said bellows chamber, the piston first portion having a variable volume, and wherein at least the first portion and the bellows are formed from a material as a single piece.
